(19) United States
(12) Patent Application Publication
(10) Pub. No.: US 2013/0176327 A1
(43) Pub. Date: Jul. 11, 2013

(54) METHOD OF RENDERING A COLOUR IMAGE WITH SPATIAL GAMUT MAPPING

(71) Applicant: OCE TECHNOLOGIES B.V., VENLO (NL)

(72) Inventor: Maurice L.M. LUTTMER, Velden (NL)

(73) Assignee: OCE TECHNOLOGIES B.V., VENLO (NL)

(21) Appl. No.: 13/779,896

(22) Filed: Feb. 28, 2013

Related U.S. Application Data
(63) Continuation of application No. PCT/EP2011/070255, filed on Nov. 16, 2011.

(30) Foreign Application Priority Data
Nov. 30, 2010 (EP) 10193045.1

(51) Int. Cl. G09G 5/02; H04N 1/60

(52) U.S. Cl. CPC G09G 5/02; H04N 1/60
USPC 345/590; 358/1.9

(57) ABSTRACT

A method of rendering a colour image from an object-based source file, including spatial gamut mapping to a target colour space, includes the steps of: rendering an image that includes a plurality of source file objects without gamut mapping, in a colour space having a gamut large enough to avoid a loss of colour information, and subjecting the rendered image to spatial gamut mapping to the target colour space.

The invention relates to a method of rendering a colour image from an object-based source file, including spatial gamut mapping to a target colour space.

When a colour image is to be reproduced, for example on a display device or a printer, the colour space of the reproduction device may have a smaller gamut than the colour space or colour spaces of the source file that represents the image. In such cases, it is necessary to apply a gamut mapping process so as to map the gamut of the source file to that of the reproduction device with a loss of information as small as possible. If an image includes relatively fine detail with only very little colour contrast, then, depending upon the gamut mapping algorithm employed, slightly different colour shades in the source image may be mapped onto the same point in the target colour space, so that the detail will be lost in the rendered image. As an example, one may consider an image of a rose wherein details within the rose blossom have only slightly different shades of red.

Spatial gamut mapping is an approach that mitigates this problem by taking into account the neighbourhood of a pixel to be rendered. When it is found that the colour of a given pixel is only slightly different from the colours of its neighbouring pixels, the gamut mapping process is modified such that the colours of the given pixel and the colour of its neighbours are mapped onto slightly different points within the gamut of the reproduction device, so that the detail will still be visible in the reproduced image. Examples of spatial gamut mapping algorithms are described in BALASUBRAMANIAN et al.: “GAMUT MAPPING TO PRESERVE SPATIAL LUMINANC VARIATIONS”, IS&T/SID COLOR IMAGING CONFERENCE, XX, XX, 1 Nov. 2000, (2000Dec. 1), page 122/123, XP001116111, EP-A1-1 107 580, WO 2009/040414 A1 and other publications that are referred to in that document. In brief, an attractive spatial gamut mapping algorithm may comprise separating the source image into a high frequency component and a low frequency component, gamut mapping the low frequency component onto the target colour space, adding the high frequency component in the target colour space and, if colours resulting from the adding step fall without the gamut of the target colour space, applying another gamut mapping step to these colours.

In an object-based image file, which may for example be a file in a page description language (PDL) such as a PostScript or PDF, the image is not given by a pixel map or bitmap that covers the entire image, but by a number of object definitions and drawing instructions for a plurality of separate objects the image is composed of. For example, the objects may comprise photos (bitmaps), vector graphics, i. e. mathematical descriptions of graphical objects, and text objects. In case of a photography, the object definition will include the bitmap, i.e. the colour values of each pixel, as well as coordinate information specifying the position where the photo is to be placed on the page, and possibly other attributes such a transparency and the like. In case of vector graphics, the object definition will comprise the mathematical description as well as attributes specifying the line width, fill colour, contour colour and the like. The definition of text objects will include the text string, e.g. a string of ASCII characters, along with attributes specifying the font type and the font size and style as well as the text colour. The various objects that compose the image may be derived from different sources such as scanners, digital cameras, drawing software and/or text processing software of a computer, and the colour specifications may therefore be given in colour spaces that differ from object to object.

The present invention aims at a method of rendering a colour image that has been specified in such an object-based source file, which method permits to further reduce the loss of information in the gamut mapping process.

To that end, the method according to the invention comprises the steps of:
rendering an image that includes a plurality of source file objects without gamut mapping, in a colour space having a gamut large enough to avoid a loss of colour information, and
subjecting the rendered image to spatial gamut mapping to the target colour space, wherein a colour of a given pixel and a colour of its neighbours are mapped onto different points in the target colour space, said spatial gamut mapping taking into account the neighbourhood of each pixel regardless of the source file objects that have determined the colours of the neighbouring pixels.

Thus, instead of applying spatial gamut mapping to each individual object in the source file, the image is first rendered into to page-size bitmap that includes a plurality of objects, preferably all the objects that have been specified in the source file. This bitmap uses a colour space the gamut of which is large enough to an encompass the gamuts of all reasonable image sources, so that the colour definitions from the source file may be converted into the bitmap colour space without any need for gamut mapping, and, consequently, without any loss of information. An example of a suitable colour space would be a Lab colour space with a and b ranging from −128 to +127 and L ranging from 0 to 100, for example. However, other colour spaces such as wide gamut RGB-like colour spaces may also be used.

Then, by applying a spatial gamut mapping to the rendered image, it is assured that the spatial gamut mapping will take into account the entire neighbourhood of each pixel, regardless of the objects that have determined the colours of the neighbouring pixels. This has the advantage that details with low colour contrast can reliably be conserved even when they are composed of different objects in the source file. For comparison, if spatial gamut mapping would be applied separately to each individual object in the source file, then the spatial gamut mapping algorithm would only take into account those neighbouring pixels that belong to the same object but would ignore neighbouring pixels that stem from other objects.

The invention also encompasses image reproduction devices and software products implementing the method that has been described above.

An embodiment example will now be described in conjunction with the drawings, wherein

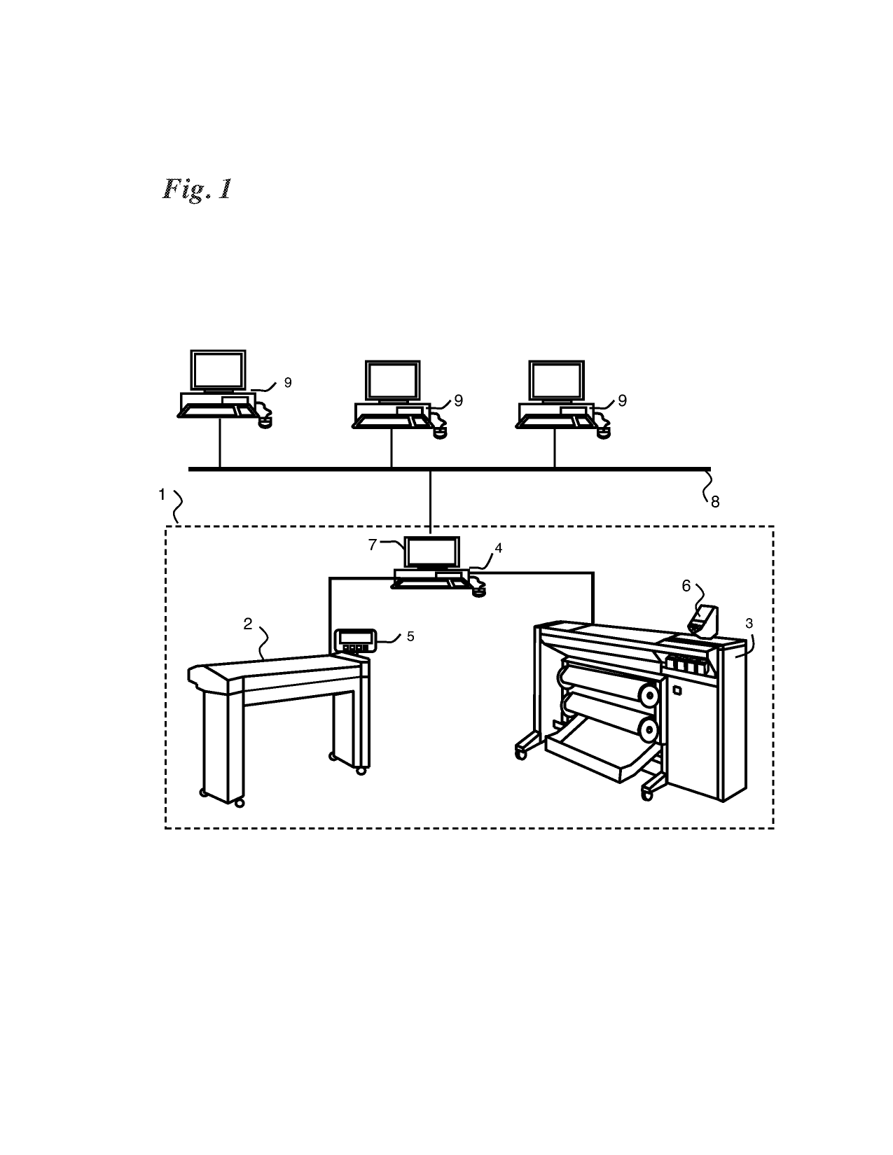

FIG. 1 is a schematic diagram of an environment comprising a reprographic system in which the invention may be implemented;

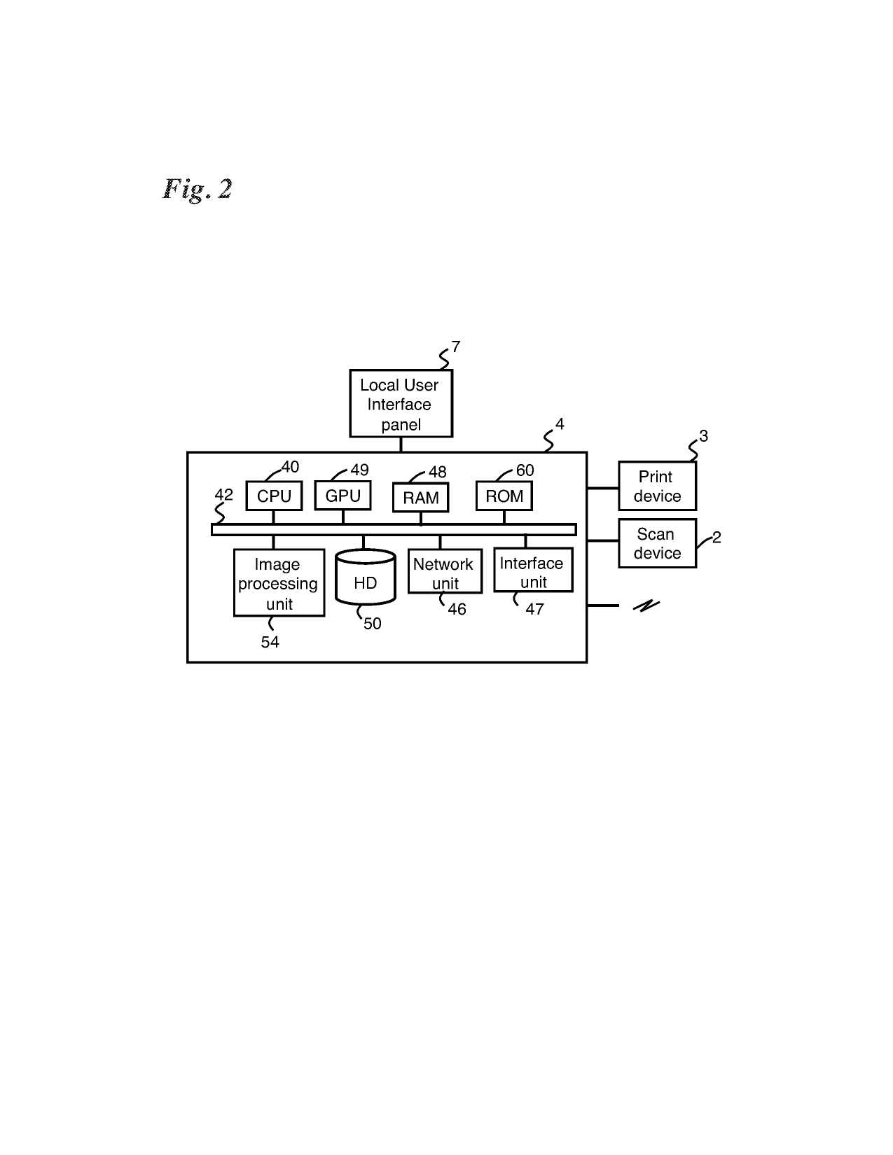

FIG. 2 is a schematic diagram of a control unit of a reprographic system according to FIG. 1.

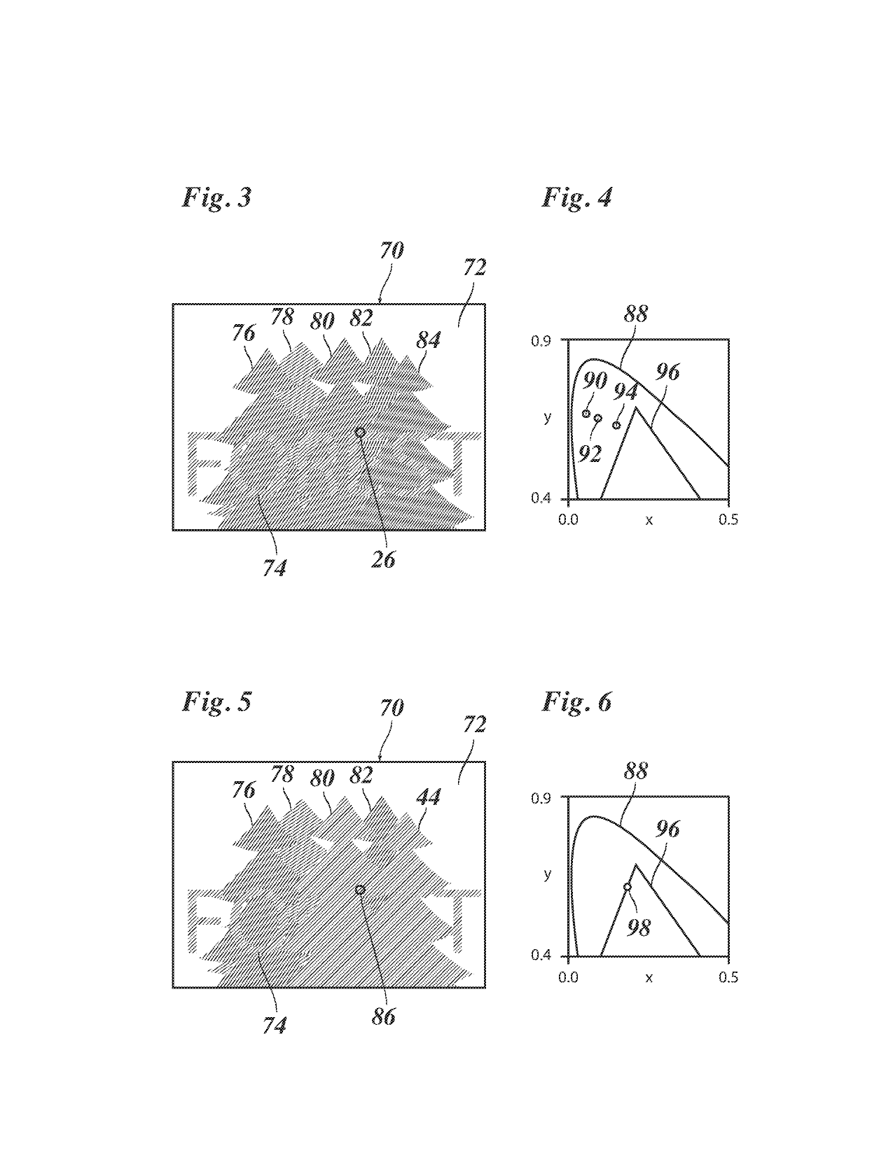

FIG. 3 is a simplified example of an image to be rendered with the method according to the invention;

FIG. 4 shows a part of an x-y-chromaticity diagram for three pixels the image in FIG. 3;

FIGS. 5 to 8 are illustrations similar to FIGS. 3 and 4 but illustrate comparative examples of rendering methods;

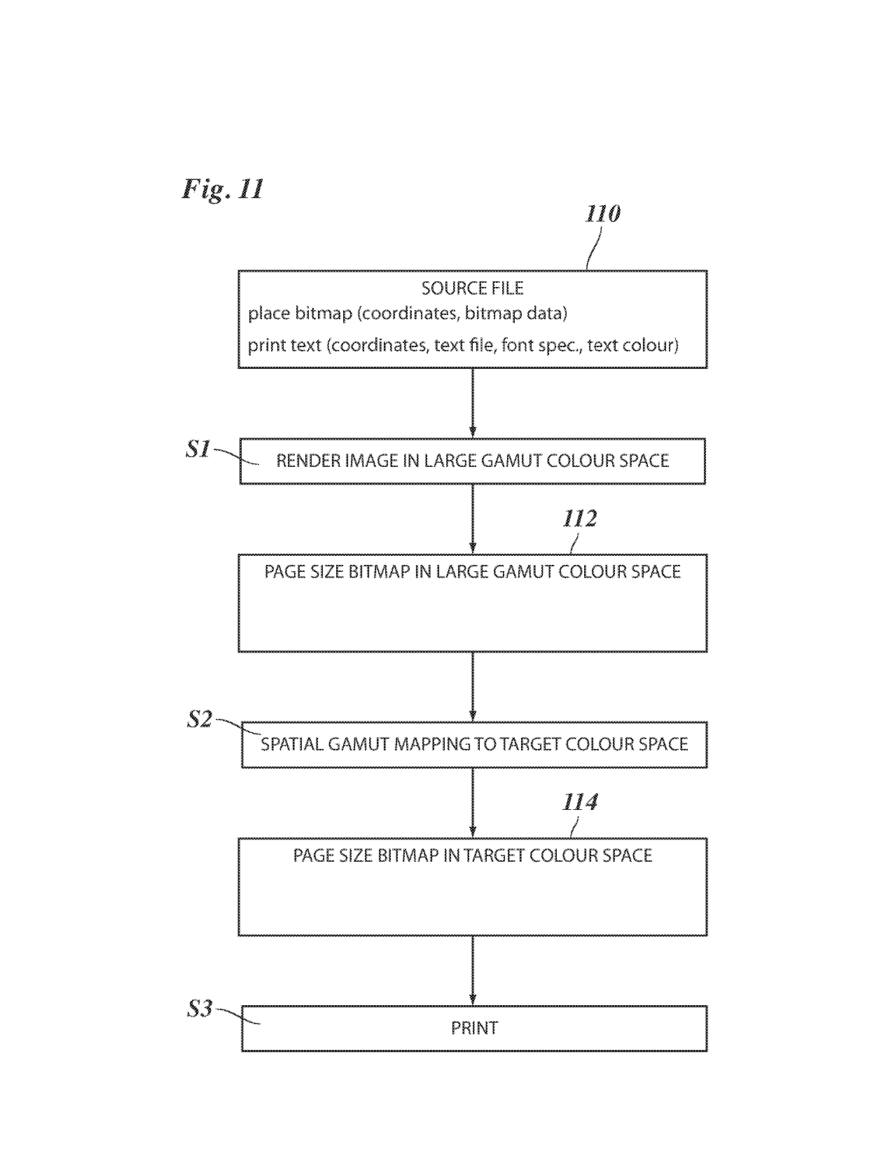

FIGS. 9 and 10 are illustrations similar to FIGS. 3 and 4 and illustrate the method according to the invention; and

FIG. 11 is a flow diagram of the method according to the invention.

FIG. 1 is a schematic diagram of an environment which comprises a reprographic system 1. The reprographic system 1 as presented here comprises a scanning device 2, a printing device 3 and a control unit 4. The control unit 4 is connected to a network 8 so that a number of client computers 9, also connected to the network 8, may make use of the reprographic system 1.

The scanning device 2 is provided for scanning an image carrying object. The scanning device 2 may be provided with a colour image sensor (i.e. a photoelectric conversion device) which converts the reflected light into electric signals corresponding to the primary colours red (R), green (G) and blue (B). The colour image sensor may be for example a CCD type sensor or a CMOS type sensor. A local user interface panel 5 is provided for starting scan and copy operations.

The printing unit 3 is provided for printing images on image receiving members. The printing unit may use any kind of printing technique. It may be an inkjet printer, a pen plotter, or a press system based on an electro-(photo)graphical technology, for instance. The inkjet printer may be for example a thermal inkjet printer, a piezoelectric inkjet printer, a continuous inkjet printer or a metal jet printer. A marking material to be disposed may be a fluid like an ink or a metal, or a toner product. In the example shown in FIG. 1, printing is achieved using a wide format inkjet printer provided with four different basic inks, such as cyan, magenta, yellow and black. The housing contains a printhead which is mounted on a carriage for printing swaths of images. The images are printed on an ink receiving medium such as a sheet of paper supplied by a paper roll. A local user interface panel 6 may be provided with input means such as buttons.

The scanning device 2 and the printing device 3 are both connected to the control unit 4. The control unit 4 executes various tasks such as receiving input data from the scanning device 2, handling and scheduling data files, which are submitted via the network 8, controlling the scanning device 2 and the printing device 3, converting image data into printable data etc. The control unit 4 is provided with a user interface panel 7 for offering the operator a menu of commands for executing tasks and making settings.

An embodiment of the control unit 4 is in more detail presented in FIG. 2. As shown in FIG. 2, the control unit 4 comprises a Central Processing Unit (CPU) 40, a Graphical Processor Unit (GPU) 49, a Random Access Memory (RAM) 48, a Read Only Memory (ROM) 60, a network unit 46, an interface unit 47, a hard disk (HD) 50 and an image processing unit 54 such as a Raster Image Processor (RIP). The aforementioned units 40, 49, 48, 60, 46, 47, 50, 54 are interconnected through a bus system 42. However, the control unit 4 may also be a distributed control unit.

The CPU 40 controls the respective devices 2 and 3 in accordance with control programs stored in the ROM 60 or on the HD 50 and the local user interface panel 7. The CPU 40 also controls the image processing unit 54 and the GPU 49.

The ROM 60 stores programs and data such as boot program, set-up program, various set-up data or the like, which are to be read out and executed by the CPU 40.

The hard disk 50 is an example of a non-volatile storage unit for storing and saving programs and data which make the CPU 40 execute a print process to be described later. The hard disk 50 also comprises an area for saving the data of externally submitted print jobs. The programs and data on the HD 50 are read out onto the RAM 48 by the CPU 40 as needed. The RAM 48 has an area for temporarily storing the programs and data read out from the ROM 60 and HD 50 by the CPU 40, and a work area which is used by the CPU 40 to execute various processes.

The interface unit 47 connects the control unit 4 to scanning device 2 and printing device 3.

The network unit 46 connects the control unit 4 to the network 8 and is designed to provide communication with the workstations 9, and with other devices reachable via the network.

The image processing unit 54 may be implemented as a software component running on an operating system of the control unit 4 or as a firmware program, for example embodied in a field-programmable gate array (FPGA) or an application-specific integrated circuit (ASIC). The image processing unit 54 has functions for reading, interpreting and rasterizing the print job data. Said print job data contains image data to be printed (i.e. fonts and graphics that describe the content of the document to be printed, described in a Page Description Language or the like), image processing attributes and print settings.

Basic modes of operation for the reprographic system are scanning, copying and printing.

With the electric signals corresponding to the primary colours red (R), green (G) and blue (B) obtained during scanning, a digital image is assembled in the form of a raster image file. A raster image file is generally defined to be an array of regularly sampled values, known as pixels. Each pixel (picture element) has at least one value associated with it, generally specifying a colour or a shade of grey which the pixel should be displayed in. For example, the representation of an image may have each pixel specified by three 8 bit (24 bits total) values (ranging from 0-255) defining the amount of R, G, and B respectively in each pixel. In the right proportions, R, G, and B can be combined to form black, white, shades of grey, and an array of colours.

The digital image obtained by the scanning device 2 may be stored on a memory of the control unit 4 and be handled according to a copy path, wherein the image is printed by the print device 3. Alternatively, the digital image may be transferred from the control unit 4 to a client computer 9 (scan-to-file path). A user of the client computer 9 may decide to print a digital image, which reflects the printing mode of operation of the system.

In the example shown in FIG. 3, an image 70 is composed of two separate objects, i.e. a photo 72, scanned for example with the scanning device 2, and a text object 74, created for example with one of the client computers 9 and superposed on the photo. The photo 72 shows a number of trees 76, 78, 80, 82, 84 which have slightly different shades of green—symbolised here by slightly different hatching. The text object 74 consists of the word “FOREST”, and the text colour is also green, so that the contrast between the text and the trees is relatively low.

A circle 86 in FIG. 3 designates a specific pixel in the image 10 that is located at a point where the areas of the trees 80 and 84 and the area of the letter “E” of the text object 74 meet.

FIG. 4 shows a corresponding part of the x-y-chromaticity diagram, wherein a curve 88 indicates the limit of 100% colour saturation. Three points 90, 92 and 94 in the diagram represent the colours of three pixels at the position of the circle 86 in FIG. 3, the point 90 belonging to a pixel of the tree 80, the point 92 belonging to a pixel of the text object 74, in the point 94 belonging to a pixel of the tree 84 in the photo 72.

A triangle in the diagram in FIG. 4 indicates the border of a gamut 96 of a reproduction device, e.g. a printer, with which the image 70 is to be printed.

If a straightforward clipping-type gamut mapping process were applied, then the three points 90, 92 and 94 would be mapped onto the nearest point on the border of the gamut 96, i.e. all three points would be mapped onto one and the same point 98, as has been shown in FIG. 6. As a result, the trees 80 and 84 and the word “FOREST” would no longer be distinguishable from one another in the rendered image, as has been shown in FIG. 5.

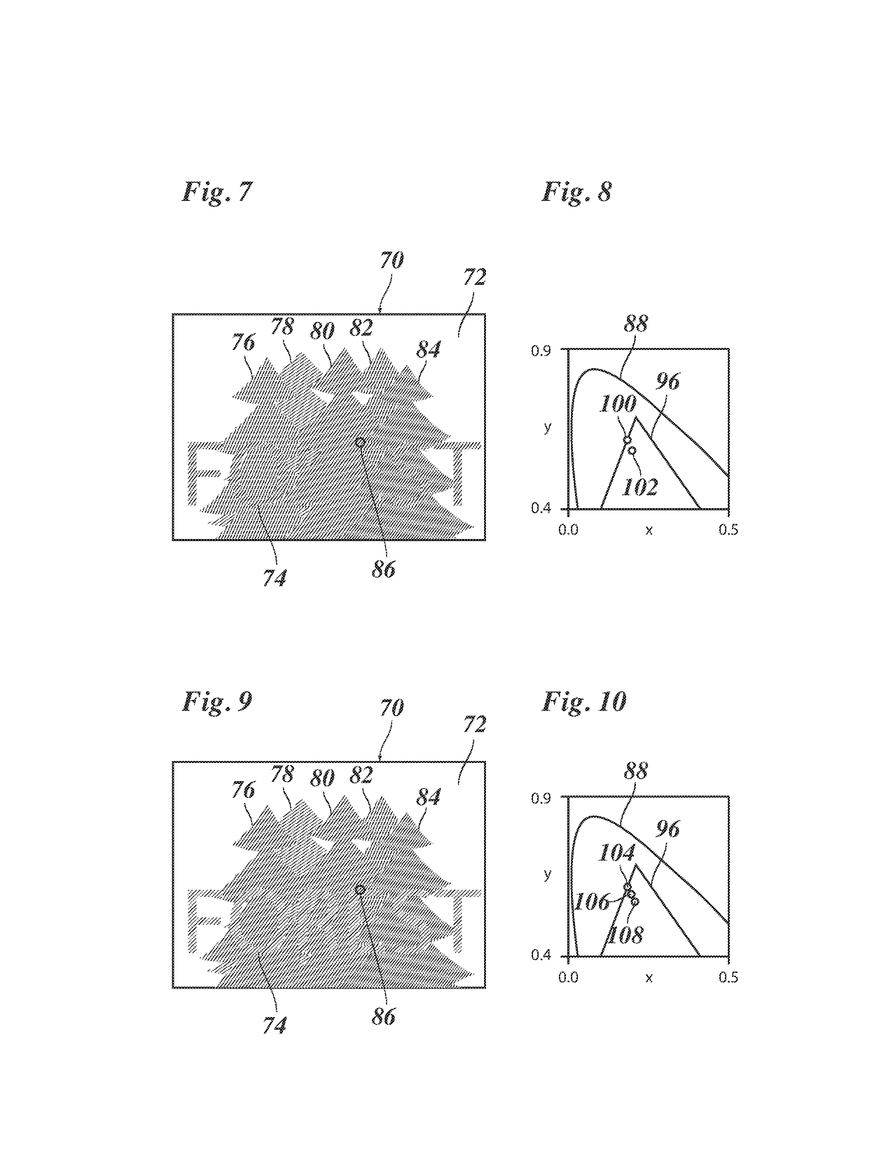

FIGS. 7 and 8 illustrate the result that would be obtained when spatial gamut mapping would be applied separately to the photo 72 and to the text object 74. The spatial gamut mapping algorithm for the photo is aware that the pixels of the photo 72 that are represented by the points 90 and 94 in FIG. 3 are direct neighbours, and therefore maps the points 90 and 94 onto different points 100 and 102 within the gamut 96, as shown in FIG. 8. However, the spatial gamut mapping algorithm applied to the photo 72 is not aware of the pixel that belongs to the point 92 in FIG. 3. Conversely, the spatial gamut mapping algorithm applied to the text object 74 is not aware of the pixels that belong to the points 90 and 94. As a result, the point 92 may be mapped onto the same point as the point 90, i.e. onto the point 100 in FIG. 8. The result has been illustrated in FIG. 7: The trees 80 and 84 remain distinguishable from one another, but the word “FOREST” does not stand out against the background of the tree 80.

In the method according to the invention, the image is at first rendered in a sufficiently large colour space, so that no gamut mapping is necessary, and then, spatial gamut mapping is applied to the rendered image. Now, the spatial gamut mapping algorithm is aware of all the pixels in the vicinity of the point designated by the circle 86 and therefore maps the corresponding colours onto different points in the gamut 96, e.g. on the points 104, 106 and 108 as shown in FIG. 10. As a result, as has been shown in FIG. 9, the trees 80 and 84 are not only distinguishable from one another but also from the word “FOREST”.

The essential steps of the method according to the invention have been illustrated in FIG. 11. The process starts with an object-based source file 110, e.g. a PDF file, a PostScript file or the like. This file includes instructions and specifications for rendering the various objects that compose the image, i. e. the image 70 shown in FIG. 3 in this example. A command “place bitmap” instructs the renderer to place the photo 72 in the page, at a position specified by coordinates that are given in the attributes of the command. In the bitmap, the colour value for each pixel of the photo are given in a suitable colour space, e.g. an RGB colour space when the photo was taken with a digital camera. A command “print text” instructs the renderer to superpose the text object 74 “FOREST” onto the photo 72 and has attributes specifying the coordinate position of the text, the text file, a font description as well as the text colour. In this case, the text colour may for example be given in a CMYK colour space.

Then, in step S1, the image is rendered, and the rendering process includes colour conversion from the colour spaces of the source file objects into a large gamut colour space such as CIELAB. This colour space has a gamut that includes the gamut of the colour space for the photo 72 and also the gamut of the colour space for the text object 74, so that no gamut mapping is necessary.

The result of this rendering process is a page-size bitmap 112.

Then, in step S2, the bitmap 112 is subjected to spatial gamut mapping, wherein the colours are mapped onto the target colour space of the image reproduction device, e.g. the printer having the gamut 96. The result is a page-size bitmap 114 in the target colour space, and this bitmap may then be printed in a final step S3, e.g. with the printing device 3.

It will be understood, that the method that has been described above may be carried out by suitable software and/or hardware modules in the reprographic system 1, e.g. in the image processing unit 54, but may also be carried out by suitable software on a multi-purpose computer.

It will also be understood that the method is subject to various modifications and may be implemented with a variety of different spatial gamut mapping algorithms, optionally combined with other colour management algorithms depending upon the respective rendering intent.

It is also within the framework of the invention that certain objects of the source file are subject to a special treatment. For example, when the source file includes text objects to be printed in black with a CMYK printer, it is common practise to specify a certain balance between the K component versus the CMY components, which means that extra information is needed in the colour definition for this object in the source file. Then, in step S1 described above, this extra information may be added to each pixel that belongs to the text, e.g. by reserving extra bits for each output pixel. This extra information will then be used in step S2 for determining the final output colour of the text pixels in the colour space of the printer.

1. A method of rendering a colour image from an object-based source file, including spatial gamut mapping to a target colour space, comprising the steps of:
rendering an image that includes a plurality of source file objects without gamut mapping, in a colour space having a gamut large enough to avoid a loss of colour information, and
subjecting the rendered image to spatial gamut mapping to the target colour space, wherein a colour of a given pixel and a colour of its neighbours are mapped onto different points in the target colour space, said spatial gamut mapping taking into account the neighbourhood of each pixel regardless of the source file objects that have determined the colours of the neighbouring pixels.

2. A printer comprising an image processing device configured to carry out the method according to claim 1.

3. A software product including program code that, when run on a computer, causes the computer to perform the method according to claim 1.
